(19) United States
(12) Patent Application Publication
(10) Pub. No.: US 2007/0245798 A1
(43) Pub. Date: Oct. 25, 2007

(54) Integral Axle Housing for Vehicle and Method of Manufacture the Same

(76) Inventor: Dongzhou Yang, Shandong Province (CN)

Correspondence Address: MARGER JOHNSON & MCCOLLOM, P.C., 210 SW MORRISON STREET, SUITE 400, PORTLAND, OR, 97204, US

(21) Appl. No.: 11/572,136

(22) PCT Filed: May 13, 2005
(86) PCT No.: PCT/CN05/00670

§ 371 Date: Jan. 15, 2007

(30) Foreign Application Priority Data
Jul. 27, 2004 (CN) 200420084920.8

(51) Int. Cl. B21D 3/00; B60B 35/16

(52) U.S. Cl. 72/367.1; 301/137; 74/607

(57) ABSTRACT

The present invention relates to an integral vehicular axle housing and a method for manufacturing the same. The axle housing comprises a central housing and axle tubes with circular sections, wherein the central housing extends towards both ends to form said axle tubes at two ends so as to form an seamless, integral structure with the axle tubes. The cross-section of the banjo-shaped portion of the central housing is rectangular, the cross-section of a portion beside the banjo-shaped portion is square, and a circular, banjo-shaped hole is formed on two larger facades of the banjo-shaped portion. An integral vehicular axle housing with such structure is advantageous in that it is of low cost, high efficiency and low pollution. Meanwhile, due to the seamless, integral structure thereof, the production is distinguished by its aesthetic appearance, high strength, and excellent overall stiffness.

### TECHNICAL FIELD

The present invention relates to an integral vehicular axle housing and a method for manufacturing the same.

### BACKGROUND

Vehicular axle housing comprises a banjo-shaped (enlarged) housing portion at center and axle tubes at two ends. In a conventional axle housing for a heavy vehicular, two axle tubes and the banjo-shaped central housing of the axle housing are welded together, and the banjo-shaped central housing is manufactured by casting or buttwelding.

A banjo-shaped central housing formed by casting is made from cast iron or cast steel. Then the axial tube is press-fitted into such formed central housing from two ends thereof after the central housing is mechanical machined. Axle housing with this structure is disadvantageous with respect to its large weight, high rejection rate, and heavy pollution to the manufacturing environment, as well as difficulty in developing variant. As for a buttwelded banjo-shaped central housing, two steel plates are punched to form the upper-half and lower-half of the axle housing., respectively. These two halves are then buttwelded together to form a complete central housing. This central housing is welded to the end axle tubes after being machined. To produce such an axle housing, large blanking device, punching device, heating device as well as welding device are needed. Therefore, the cost is high and the material utilizing rate is low. Additionally, In whatever cases, axle tubes are welded at the two ends of the central housing so as to form a two-parts structure, which leads to an ugly appearance. Meanwhile, since the central housing and axle tubes are welded together, for the axle head portion with a small diameter, it can only be welded from its outer surface using one-side welding. Therefore it is difficult to guarantee the quality of the welding. Due to thermal stress developed during welding process, materials adjacent to the welding seam are of low strength and stiffness therefore is easy to break at welding seams. Thus, the axle housing is defective and the reliability thereof is low.

### SUMMARY OF THE INVENTION

An object of the present invention is to overcome above shortcomings in conventional axle housings, and to provide an integral vehicular axle housing with an aesthetic appearance, high overall strength, high stiffness, low cost and low pollution.

An integral vehicular axle housing according to the present invention comprises a central housing and axle tubes with circular sections, wherein the central housing extends towards both ends to define axle tubes at two end so as to forms an seamless, integral structure with the axle tubes, in which a cross-section of the banjo-shaped portion of the central housing is rectangular, a cross-section of portion beside the banjo-shaped portion is square, and a circular, banjo-shaped hole is provided on two larger facades of the banjo-shaped portion.

With the integral configuration of the central housing and axle tubes, the integral vehicular axle housing according to the present invention may be formed by extending and shrinking formation. Therefore, advantages such as low cost, high efficiency and low pollution are achieved. Meanwhile, due to the seamless, integral structure thereof, the product is distinguished by its aesthetic appearance, high strength, and excellent stiffness.

The present invention also provide a method to manufacture a vehicular axle housing, which comprises the steps of:
(a) providing a seamless steel tube with a cylindrical or square wall and a central axis; a central portion and two extension portions extending in opposite directions from said central portion respectively being defined along said center axis;
(b) providing two diametrically opposed weakness zones or through-slots on the cylindrical tubular wall or forming two weakness zones or through-slots on two opposed sides of the square tubular wall in the central portion along the central axis;
(c) expanding apart the central portion of the steel tube along a normal line of a plane defined by the weakness zones or through-slots, until a desired profile for the vehicular axle housing is achieved, wherein a deforming transition segment is defined in part of each extension portion adjacent to the central portion, and no obvious plastic deformation occurs in the seamless steel tube apart from the deforming transition segment.

It is preferred to further comprise a step of shrinking the seamless steel tube at end portion where plastic deformation has not happened.

It is preferred to further comprise a step of mechanically machining the end portion where plastic deformation has not happened.

It is most preferred to further comprise a step of rounding the end edges of the weakness zones or through-slots.

### BRIEF DESCRIPTIONS OF THE DRAWINGS

FIG. 1 is a structural view of a preferred integral vehicular axle housing according to the invention;

FIG. 2 is a sectional view along the line A-A in FIG. 1;

FIG. 3 is a sectional view along the line B-B in FIG. 1;

FIG. 4 is a sectional view along the line C-C in FIG. 1;

FIG. 5 is a sectional view along the line D-D in FIG. 1.

### EMBODIMENTS

An integral vehicular axle housing according to the invention will be further described with reference to accompany drawings.

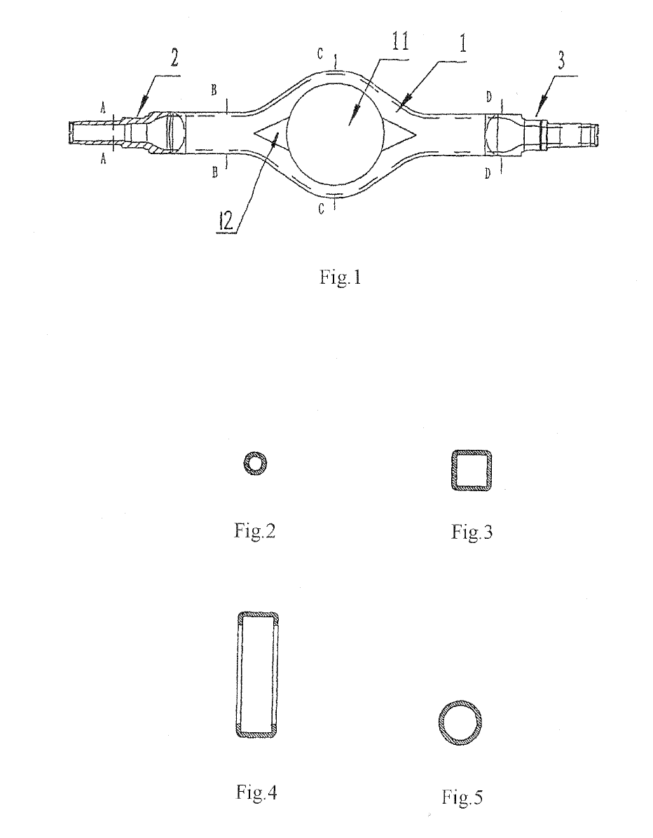

As shown in FIG. 1, an integral vehicular axle housing comprises a central housing 1 and axle tubes 2 and 3 with circular sections at two ends thereof. The central housing 1 extends toward two ends to form an integral structure with the axle tubes 2 and 3, without any welding seams between the central housing 1 and the axle tubes. FIG. 4 shows a sectional view of the banjo-shaped portion of the central housing along line C-C in FIG. 1, from which we can learn that the section is rectangular. FIG. 3 shows a sectional view of the portion near to the banjo portion along the line B-B of FIG. 1, from which we can learn that the section is square. A circular, banjo-shaped hole 11 is formed on the larger facades of the banjo-shaped portion. As shown in FIGS. 2 and 5, the A-A profile of the axle tubes 2 or 3 at two ends is circular, and a D-D profile of a transition portion between the central housing 1 and the axle tubes 2, 3 is also circular.

The integral vehicular axle housing of this invention is manufactured from a seamless steel tube. After extending outwardly at the central portion, the central housing I defines a circular, banjo-shaped hole 11, while two ends thereof shrink gradually to form two axle tubes 2 and 3. The cross-section of the central banjo-shaped portion is rectangular, which gradually transit into square at the two ends, and further transit into a circular cross-section for the axle tube 2 or 3 by a circular transitional region (namely the D-D profile portion). This configuration simplifies the outspreading process as well as shrinking process, and may guarantee the machining accuracy and quality. The banjo-shaped hole 11 is a circular configuration, which is advantageous in that stress may be distributed more rationally when the axle housing centrally is loaded when comparing to a polygonal hole, thus the strength of the structure is improved.

The banjo-shaped hole 11 is formed on the larger facades of the central axle housing 1, two triangular steel plates 12 are welded to the central axle housing 1 at two opposite sides of the hole 11. For the rectangular profile of B-B for the central housing 1, the length and width thereof is in the range of 80 to 170 mm. Such a size range may provide for a safe axle housing for a heavy loaded vehicular, as well as an economic usage of material. An outer diameter of a bearings-mounting portion of the axle tubes 2 or 3, namely the outer diameter of the circular cross-section along line A-A, is in the range of 50 to 120 mm.

The present invention also provides a method to manufacture a vehicular axle housing, comprising the steps of:
(a) providing a seamless steel tube with a cylindrical or square wall and a central axis; a central portion and two extension portions extending in opposite directions from said central portion respectively being defined along said center axis;
(b) providing two diametrically opposed weakness zones or through-slots on the cylindrical tubular wall or forming two weakness zones or through-slots on two opposed sides of the square tubular wall in the central portion along the central axis;
(c) expanding apart the central portion of the steel tube along a normal line of a plane defined by the weakness zones or through-slots, until a desired profile for the vehicular axle housing is achieved, wherein a deforming transition segment is defined in part of each extension portion adjacent to the central portion, and no obvious plastic deformation occurs in the seamless steel tube apart from the deforming transition segment.

It is preferred to further comprise a step of shrinking the seamless steel tube at end portion, where the plastic deformation has not happened.

It is preferred to further comprise a step of mechanically machining the end area where plastic deformation has not happened.

It is most preferred to further comprise a step of rounding the end edges of the weakness zone or through-slots.

1. An integral vehicular axle housing, comprising a central housing and axle tubes with circular sections, wherein the central housing extends towards both ends to define said axle tubes at two ends such that a seamless, integral structure is formed by the central housing and the axle tubes, and in which a banjo-shaped portion of the central housing has a rectangular cross-section, a portion beside the banjo-shaped portion has a square cross-section, and a circular, banjo-shaped hole is provided on two larger facades of the banjo-shaped portion.

2. An integral vehicular axle housing according to claim 1, characterized in that: the central housing and axle tubes are formed from seamless steel tubes.

3. An integral vehicular axle housing according to claim 1 characterized in that: a length and width of the cross-section of the banjo-shaped portion of the central housing is in a range of 80 to 170 mm.

4. An integral vehicular axle housing according to claim 1 characterized in that: an outer diameter of a bearing-mounting portion of the axle tubes is in a range of 50 to 120 mm.

5. A method to manufacture a vehicular axle housing, comprising the steps of:
(a) providing a seamless steel tube with a cylindrical or square wall and a central axis; a central portion and two extension portions extending in opposite directions from said central portion respectively being defined along said center axis;
(b) providing two diametrically opposed weakness zones or through-slots on the cylindrical tubular wall or forming two weakness zones or through-slots on two opposed sides of the square tubular wall in the central portion along the central axis;
(c) expanding apart the central portion of the steel tube along a normal line of a plane defined by the weakness zones or through-slots, until a desired profile for the vehicular axle housing is achieved, wherein a deforming transition segment is defined in part of each extension portion adjacent to the central portion, and no obvious plastic deformation occurs in the seamless steel tube apart from the deforming transition segment.

6. A method according to claim 5, further comprising a step of shrinking the seamless steel tube at an end portion where plastic deformation has not happened.

7. A method according to claim 6, further comprising a step of mechanically machining the end portion where plastic deformation has not happened.

8. A method according to claim 5, further comprising a step of rounding end edges of the weakness zone or through-slots.

9. An integral vehicular axle housing according to claim 2, characterized in that: a length and width of the cross-section of the banjo-shaped portion of the central housing is in a range of 80 to 170 mm.

10. An integral vehicular axle housing according to claim 2, characterized in that: an outer diameter of a bearing-mounting portion of the axle tubes is in a range of 50 to 120 mm.

11. An integral vehicular axle housing, comprising,
a central housing having a banjo-shaped portion, the banjo-shaped portion having a rectangular cross-section;
two elongated tubular portions, extending in opposite directions from the banjo-shaped portion and each tubular portion having an end;
two axle tubes, each coupled to the end of each tubular portion to form a seamless, integral structure, each axle tube having a circular cross-section; and
each tubular portion having a square cross-section adjacent to the banjo-shaped portion and transitioning to the circular cross-section at the end of each tubular portion.

12. An integral vehicular axle housing according to claim 11, in which the cross-section of the banjo-shaped portion has a length and width in a range of 80 to 170 mm.

13. An integral vehicular axle housing according to claim 11, in which the axle tubes have a bearing-mounting portion with an outer diameter in a range of 50 to 120 mm.

14. An integral vehicular axle housing according to claim 11, further comprising a circular banjo-shaped hole formed on the banjo-shaped portion of the central housing.
